(19) United States
(12) Patent Application Publication
(10) Pub. No.: US 2013/0179394 A1
(43) Pub. Date: Jul. 11, 2013

(54) System and Method for Interpreting and Generating Integration Flows

(71) Applicant: Alkiviadis Simitsis, Santa Clara, CA (US)

(72) Inventor: Alkiviadis Simitsis, Santa Clara, CA (US)

(21) Appl. No.: 13/821,110

(22) PCT Filed: Sep. 10, 2010
(86) PCT No.: PCT/US2010/048399

§ 371 Date: Mar. 6, 2013

(51) Int. Cl. G06F 17/30

(52) U.S. Cl. CPC G06F 17/30227
USPC 707/602

(57) ABSTRACT

There is provided a computer system for generating an extract, transform, and load (ETL) workflow. The computer system includes a processor configured to receive (502) an ETL workflow, generate (504) a symbolic representation of the ETL workflow, generate (506) an improved representation, and generate (508) the improved ETL workflow. The improved representation may be a symbolic representation of the improved ETL workflow. Generating the improved ETL workflow may be based on the improved representation.

### BACKGROUND

The back-end of a data warehouse includes many software modules responsible for populating the data warehouse with relevant data. The relevant data may be extracted from the various source systems, transformed, and cleansed to comply with target schemata.

Such software modules are commonly known as Extract-Transform-Load (ETL) operations (also referred to herein as ETL activities). ETL operations are the building blocks of ETL workflows.

ETL workflows populate and maintain the data warehouse. ETL workflows are quite complex by nature, mostly due to the large volume of different activities included in such processes. Many commercial tools are available to facilitate the creation of ETL workflows. The design and execution of ETL workflows using the commercial tools implicates design and maintenance issues for the data warehouse.

### BRIEF DESCRIPTION OF THE DRAWINGS

Certain embodiments are described in the following detailed description and in reference to the drawings, in which:

FIG. 1 is a block diagram that is useful in explaining an ETL transformation in a system adapted to generate ETL workflows according to an embodiment of the present invention;

FIGS. 2A-2D are block diagrams showing atom-like structures that represent ETL transformations according to an embodiment of the present invention;

FIGS. 3A-3B are block diagrams of the internal representations of ETL atoms according to an embodiment of the invention;

FIG. 4 is a block diagram of the internal representations of an ETL molecule according to an exemplary embodiment of the invention;

FIG. 5 is a process flow diagram showing a computer-implemented method for generating ETL workflows according to an embodiment of the invention;

FIG. 6 illustrates two molecules coupled together according to an embodiment of the invention;

FIGS. 7A-7B are block diagrams that shows two variations of swapping ETL transformations according to an embodiment of the invention;

FIG. 8 is a block diagram of a system adapted to generate ETL workflows according to an embodiment of the present invention; and

FIG. 9 is a block diagram showing a non-transitory, machine-readable medium that stores code adapted to generate ETL workflows according to an embodiment of the present invention.

### DETAILED DESCRIPTION

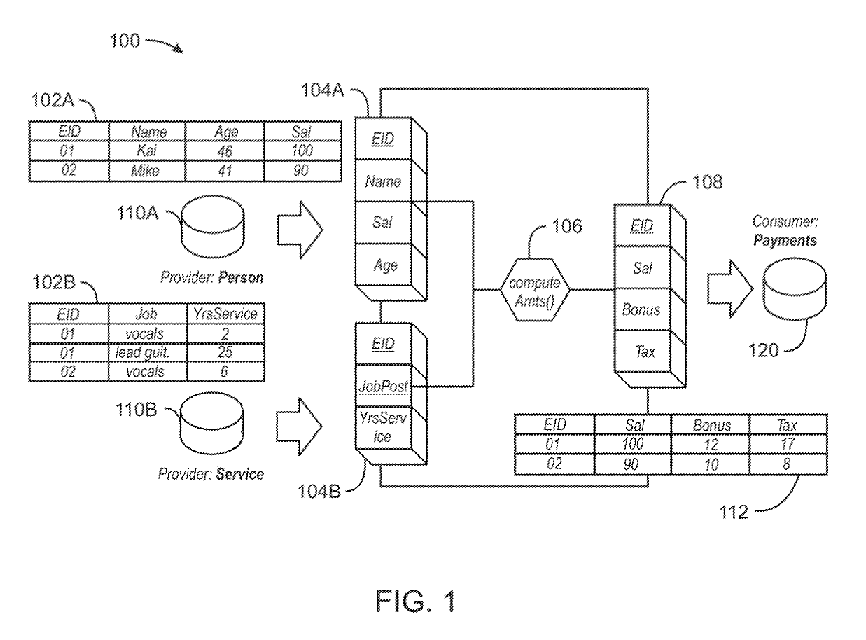

FIG. 1 is a block diagram that is useful in explaining an ETL transformation 100 in a system adapted to generate ETL workflows according to an embodiment of the present invention. The ETL transformation 100 may include providers 110A, 110B, a consumer 120, input recordsets 102A, 102B, output recordset 112, input schemas 104A, 104B, an output schema 108, and an ETL operation, i.e., activity 106.

Typical activities include schema transformations (e.g., pivot, normalize), cleansing activities (e.g., duplicate detection, check for integrity constraints violations), filters (based on regular expressions), sorters, groupers, flow operations (e.g., router, merge), function application (e.g., built-in functions, scripts (in declarative programming languages), calls to external libraries, e.g., ‘black-box’, etc.

The ETL transformation 100 may combine the activity 106 with its providers 110A, 110B, and consumer 120. Each input schema 104A, 104B may be mapped to the provider's recordset 102A, 102B. In some scenarios, the provider 110A, 110B or the consumer 120 may map an input schema to an output schema of another activity.

As shown, the activity 106, “computeAmts” receives inputs from the providers, “Person” and “Service.” The activity 106 outputs to a single consumer, “Payments.”

Internally, the inputs of the activity 106 populate outputs according to operational semantics of the activity 106. For example, the “computeAmts” activity may populate the output recordset 112 according to formulas for calculating salaries, bonuses, and taxes.

The input schemas 102A, 102B may not map directly to the output schema 108. For example, the output schema 108 contains two new attributes, “Bonus” and “Tax.”

As understood by one skilled in the art, ETL transformations may be combined to produce a workflow. An ETL workflow may include a sequence of ETL transformations, some of which provide inputs to subsequent transformations. The ETL workflow may include relationships between activities and recordsets.

Each relationship between an activity and a recordset may represent inputs and outputs of ETL transformations. A relationship from an activity to a recordset may represent output of the ETL transformation. A relationship from a recordset to an operation may represent input to another ETL transformation. In this manner, the beginning and end of the ETL workflow may represent relationships between providers of source data and consumers of target data. The relationships between the providers and consumers may be described as combinations of the activities and recordsets in the ETL workflow.

ETL transformations may be classified according to the interrelationship of the input and output. At a high level, using the numbers of input and output schemas ETL transformations may be described as: unary, binary, and n-ary. A unary transformation has one input schema and one output schema. An n-ary transformation may have multiple input schemas and one output schema. A binary transformation may be a special case of the n-ary transformation, with 2 input schemas.

Different tools provide different implementations regarding the input schemata. An n-ary activity (e.g., a multi-way join) may have n inputs, or can be implemented as a series of binary activities. It should be noted that implementations of the various techniques described herein describe both n-ary and binary activities. However, for the sake of clarity, the following discussion merely describes binary activities.

Binary transformations include two popular configurations: combinators and primary flow. Combinator transformations have output schemas that are a combination of values from multiple input schemas.

In primary flow transformations, a first input is tested against a second input to determine whether to propagate the first input. Input recordset data that is included in the output recordset may be considered to be propagated.

The use of surrogate keys provides one example of a primary flow transformation. As understood by one skilled in the art, production keys from input recordsets (the first input) may be replaced in the output recordset with surrogate keys.

The surrogate keys may be considered the second input in that the surrogate keys may be input to the primary flow transformation as lookup tables. The activity may look up the surrogate key in the lookup tables using the input production key.

ETL transformations may also be classified in terms of their outputs. Two possible output classifications are routers and filters. In router transformations, the content of each particular output is determined based on values of the input. For example, each tuple of an input recordset may be routed to a specific path of the ETL workflow. The particular path may be determined based on a column value in the row.

In an ETL workflow, filters may select, according to specified criteria, particular tuples for further processing, and block the remaining. The selected tuples may populate one or more output schemas. Typical filters populate one output schema. However, a conditional filter may direct output tuples among multiple paths in the ETL workflow.

The tuples that are blocked from further processing may be stored in an error log. Alternatively, blocked tuples may be stored according to quarantine error schemata. An ETL transformation with quarantine error schemata may isolate tuples with offending values, preventing further processing in the regular ETL workflow. Instead, isolated tuples may be directed towards quarantine or other specified processing.

Within the unary classification, ETL transformations may be further classified according to the relationship between the number of tuples in the input and output recordsets. These relationships are described in Table 1:

TABLE 1

| Tuple | |
|---|---|
| Relationship | Description |
| 1:1 | An input tuple is mapped to exactly one output tuple |
| 1:M | An input tuple is mapped to more than one output tuple |
| N:1 | More than one input tuple are combined to produce exactly |
| | one output tuple |
| 0:M | A function or constant value may be used to produce one or |
| | more output tuples |
| N:M | All other relationships |

ETL transformations with a 1:1 tuple relationship may be row-level transformations. A row-level transformation may include a function applied locally to a single row.

ETL transformations with a 1:M tuple relationship may be grouper transformations. Grouper transformations may transform a set of tuples to a single tuple.

ETL transformations with an N:1 tuple relationship may be splitter transformations. Splitter transformations may split a single tuple into a set of tuples.

It should be noted that in an N:1 relationship, the input tuples may be grouped according to classes. All tuples belonging to the same class correspond to the same output tuple. If the classes are equivalence classes, each input tuple belongs to at most one class.

ETL transformations with an M:N tuple relationship may be holistic. Holistic transformations may perform a transformation to the entire input recordset.

As stated previously, commercial tools facilitate the creation of ETL workflows. However, each ETL tool follows a different approach for the modeling of ETL operations. As such, there is typically no standard approach for describing ETL operations.

Without a standard approach, it is challenging to improve the quality and efficiency of ETL workflows in a systematic manner or to perform other useful analysis, such as impact analysis, and exploring alternative scenarios.

Table 2 shows a classification of transformations provided by some commercial ETL tools:

TABLE 2

| Classi- | Microsoft SQL | | Oracle Warehouse |
|---|---|---|---|
| fication | SSIS | DataStage | Builder |
| Unary (1:1) | Character map | Transformer | Deduplicator |
| | Copy column | Remove | Filter |
| | Data conversion | duplicates | Sequence |
| | Derived column | Modify (drop/ | Constraint |
| | Script component | keep/change | Table function |
| | OLE DB cmd | type of column) | Data cleansing |
| | Other filters (not | | (e.g., name and |
| | null, etc.) | | address) |
| | | | Other (character, |
| | | | date, etc.) |
| Unary (M:1) | Aggregate | Aggregator | Aggregator |
| | Pivot | Combine/ | Pivot |
| | | Promote records | |
| Unary (1:N) | Unpivot | Make/Split | Unpivot |
| | | record | |
| | | Make/Split vector | |
| Unary (M:N) | Sort | Sort (sequential/ | Sorter |
| | Percentage | parallel/total) | |
| | sampling | | |
| | Row sampling | | |
| N-ary | Union all | Funnel | Set (union, union |
| | Merge | Join | all, intersect, minus) |
| | Merge join (MJ) | Merge | Joiner |
| | Lookup (SKJ) | Lookup | Key lookup (SKJ) |
| | | Change capture | |
| | | Difference (tuple) | |
| | | Compare (col) | |
| Router | Conditional split | Copy | Splitter |
| | Multicast | Filter | |

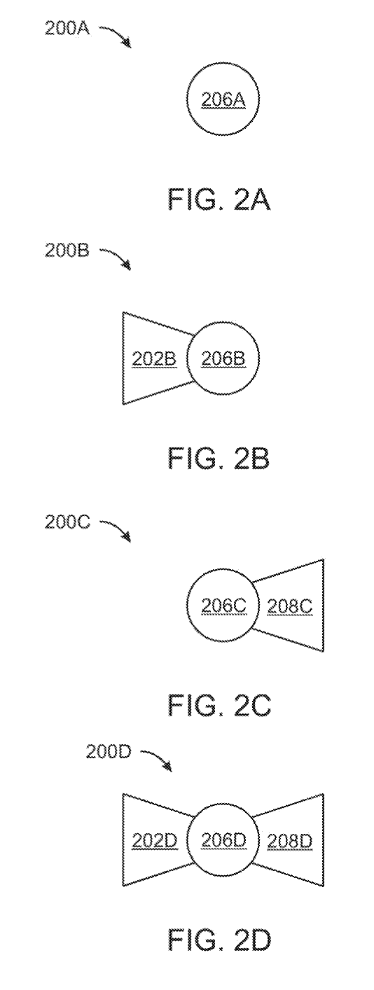

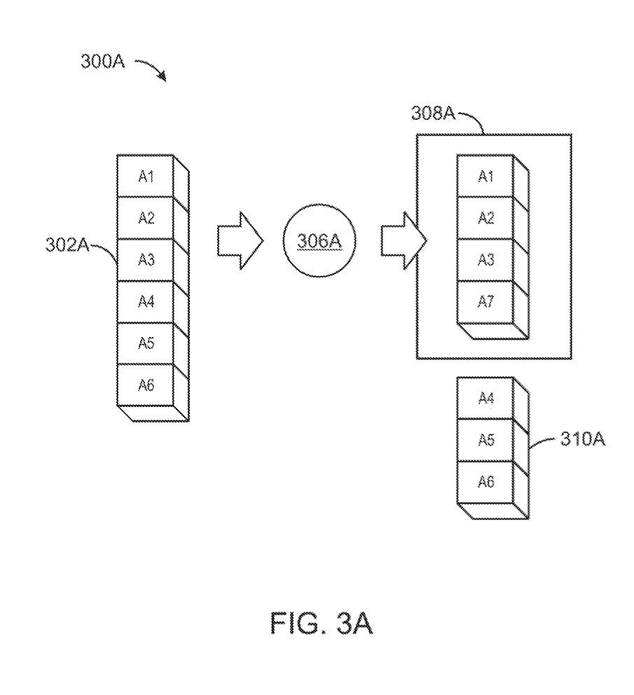

FIGS. 2A-2D are block diagrams showing atom-like structures that represent ETL transformations according to an embodiment of the present invention. The domain of physics provides an analogy for ETL transformations, wherein an ETL transformation may be represented as atom and molecular-like structures.

In this analogous vocabulary, an ETL particle may represent a single activity of an ETL transformation. As such, when a user adds an activity to a canvas of an ETL toolset, the user can be said to be introducing a particle into the design.

In a scenario where the ETL toolset includes a library of template tasks, the particle may be a materialization of a template for a specific schema-respecting input. As such, the semantics of the particle may be captured via a simple predicate with commonly agreed-upon semantics. The particle is also referred to herein as the nucleus of an ETL atom.

The ETL atom may represent a simple ETL transformation that performs one job and includes one ETL particle. When the user customizes the schemata of an ETL transformation and connects the ETL transformation to providers and consumers, the ETL atom is defined.

The number of output schemata of the ETL atom may be greater than one. Further, several input attributes may be filtered out. Additionally, new attributes may be generated in the output schemata. FIGS. 2A-2D represent different forms of the ETL atom based on the number of input and output schemata.

The ETL atom 200A may include a particle 206A. The ETL atom 200A may represent an ETL transformation with one input schemata and one output schemata.

The ETL atom 200B may include multiple input schemata 202B, and an ETL particle 206B. The ETL atom 200A may represent an ETL transformation with multiple input schemata and one output schemata.

The ETL atom 200B may include an ETL particle 206C, and multiple output schemata 208C. The ETL atom 200C may represent an ETL transformation with one input schemata and multiple output schemata 208C.

The ETL atom 200D may include multiple input schemata 202D, an ETL particle 206D, and multiple output schemata 208D. The ETL atom 200D may represent an ETL transformation with multiple input schemata 202D and multiple output schemata 208D.

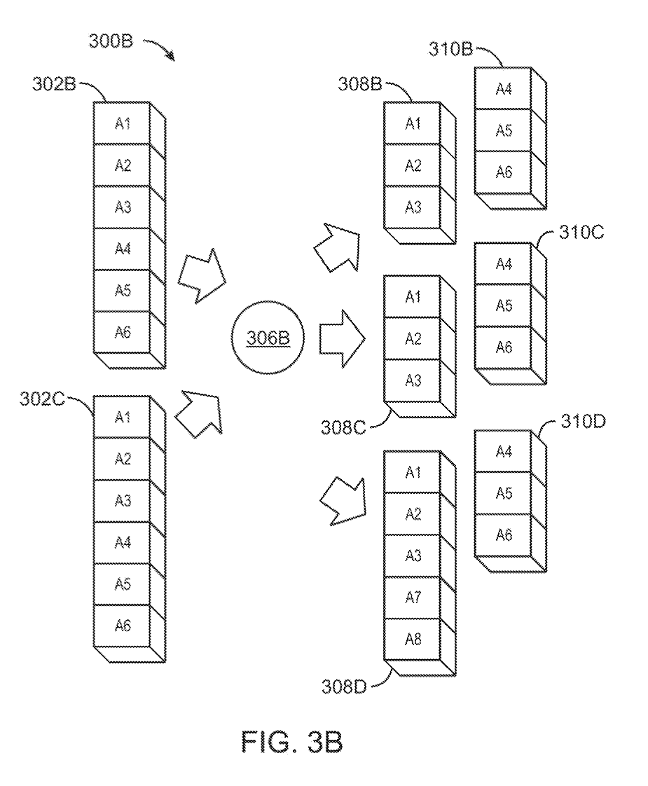

FIG. 3A is a block diagram of the internal representations of a unary ETL atom 300A according to an embodiment of the invention. The unary ETL atom 300A may include input schemata 302A, an ETL particle 306A, and output schemata 308A. The input schemata 302A includes attributes labeled “A1-A6.”

The block of attributes 310A includes attributes “A4-A6” that are not propagated to the output schemata 308A. As shown, the output schemata 308A includes a new attribute, “A7.”

FIG. 38 is a block diagram of the internal representations of a binary ETL atom 300B according to an embodiment of the invention. The binary atom 300B may include input schemata 302B, 302C, ETL particle 306B, and output schemata 308B, 308C, 308D.

The ETL transformation represented by the binary ETL atom 300B may perform all the individual subtasks that may be performed by an ETL transformation. Two input schemata 302B, 302C may be merged. Two new attributes, “A7,” and “A8,” may be computed. The output recordsets may be routed to the appropriate output schemata 308B, 308C, or 308D. Also, several attributes, “A4-A6” may be filtered out. The filtered attributes are shown in blocks 310B, 310C, 310D.

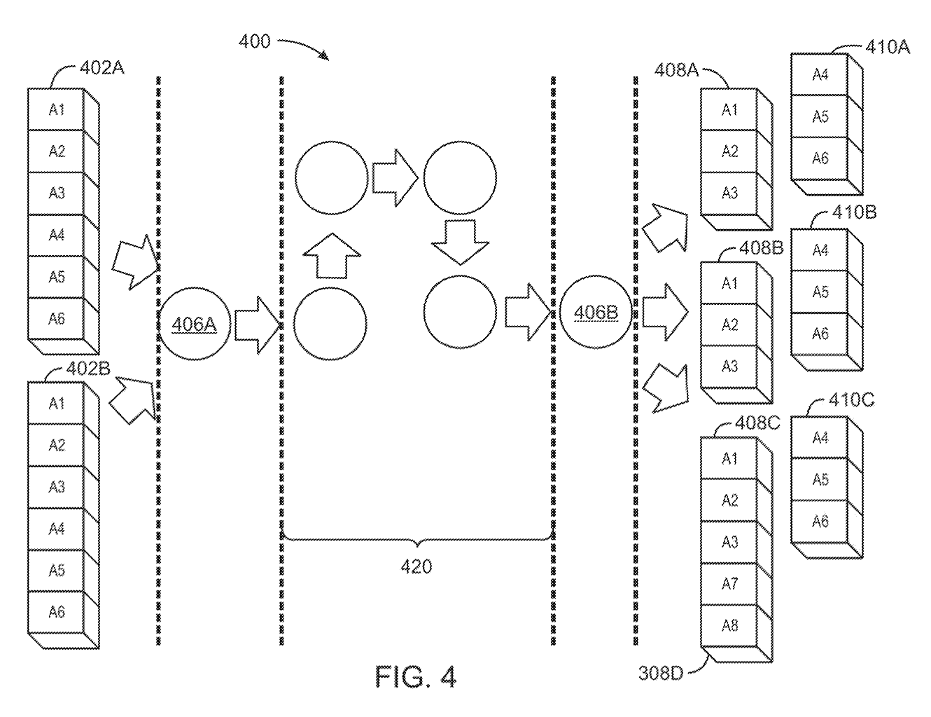

In an embodiment of the invention, ETL atoms may be combined to form an ETL molecule. FIG. 4 is a block diagram of the internal representations of an ETL molecule 400 according to an exemplary embodiment of the invention.

The ETL molecule 400 may include input schemata 402A, 402B, ETL particles 406A, 406B, internal transformations 420, and output schemata 408A, 408B, and 408C. As shown, the ETL molecule 400 includes two new attributes, “A7,” and “A8,” in the output schemata 408C. Additionally, filtered-out attributes “A4-A6” are represented in blocks 410A, 410B, 410C.

The ETL molecule 400 may represent a typical case in hand-tailored code where several functionalities are merged within the same script. In such a case, instead of a single particle, there may be a linear workflow of particles, i.e., 406A, 420, 406B, between two groups of schemata (402A, 402B and 408A, 408B, 408C).

The line of particles 406A, 420, 406B between the merger of the inputs and the router for the outputs is referenced herein as the chain of the molecule. The semantics of a molecule may be defined as follows: for each output, the semantics are expressed as the conjunction of the predicates all the way to the inputs.

As ETL atoms may be combined to form ETL molecules, ETL molecules may be combined to form ETL compounds. The ETL compound may represent an ETL workflow. As such, using the form described above, an ETL designer may generate a proprietary ETL workflow from scratch. Additionally, the form described above may provide a means for interpreting any ETL workflow using a common language and a formal normal form. In one embodiment of the invention, a generic optimizer may use this normal form to interpret, optimize, and re-generate an ETL workflow, irrespective of the origins of the ETL workflow.

The ETL particles, ETL atoms, ETL molecules, and ETL compounds described above may be represented in a normal form. Assuming an infinitely countable set of attribute names, Ω, a schema S may include a finite list of attributes S=[A_{1 . . .} , Aₙ], where Aᵢ ∈ Ω, i=1 . . . n. Each attribute Aᵢ may be associated with a domain, i.e., dom(A).

A formula for a selection condition may be true, false or an expression of the form, x θ y, where θ is an operator from the set (>,<,=,≧,≦,≠) and each of x and y can be one of the following: (a) an attribute A, (b) a value I belonging to the domain of an attribute, I ∈ dom(A). A selection condition φ may be a formula that combines atomic formulae in disjunctive normal form.

In addition, an assumption may be made of an infinitely countable set of template activity names, Λ. Each template activity, t ∈ Λ may be accompanied by a predicate name Pₜ( ) and a finite set of parameter names D={D₁ . . . , Dₘ}. The predicate, Pₜ( ), may carry commonly accepted, interpreted semantics for the template. For example, a template activity, notNull, with commonly accepted semantics of testing inputs for not null values, may be expressed as a parameter D₁.

An ETL particle may be an, instantiation of the template activity over a concrete schema that maps the parameter names of the template to a specific set of attributes Pₜ(X), where X=[X₁ . . . , Xₙ], Xᵢ ∈ Ω, i=1 . . . n. Accordingly, the template activity, notNull, with a set of parameter names D={D₁}, may be represented in the form, notNull(Age), where D₁ is substituted with an attribute, Age.

A specific subset of the template activities, M, may involve activities that merge several input schemata (e.g., join( ), diff( ), sortedUnion( ), partialDiff( ), etc.). The members of this set are referred to herein as mergers. A router, r, may be defined as a finite set of selection conditions (not necessarily disjoint with each other).

As such, an ETL atom may be expressed as a pentad of the form (I, m( ), P(X), r, O), where I is a finite set of input schematas, m is a merger, P(X) is a materialization of a template predicate over the schema X, r is a router, and O is a finite set of output schemata. It should be noted that P(X) is referred to herein as the functionality schema of the ETL atom.

The following well-formedness constraints hold for an ETL atom: 1) X is a subset of the union of attributes of the schemata, I, and 2) There is a 1:1 mapping between the selection conditions of r, and the output schemata of O.

Assuming O=[O₁ . . . , Oₙ], and r=[φ₁ . . . , φ₁ₙ], the condition, φᵢ, may correspond to schema Oᵢ for all i=1 . . . n. Also, assuming X=[X₁ . . . Xₙ], the semantics of a tuple, t, arriving at an output schema, Iᵢ, may be merge(I) Λ P(t.X₁ . . . , t.Xₙ) Λ φ₁. It should be noted that a true merger particle and single outputs may have single valued {true} router particle.

For example, referring back to Tables 1 and 2, grouper transformations may be represented as an atom of the form (I₁, true, group(X_{groupers}, X_{grouped}), true, O₁). A binary atom may be represented as an atom of the form (I(I₁, I₂), join(join-fields), true, true, O₁).

More complex atoms with one particle can also be expressed in this form. For example, a join ETL atom may merge schematas for items and orders. The join ETL atom may also convert Euros to Dollars values over a cost attribute, and route the results according to the following criteria. The output schemata is O₁ if the dollar cost is higher than $500, the output schemata is O₂ in any other case. This transformation may be expressed as: (I(I_{ORDERS}, I_{ITEMS}), join(O.I_ID=I.IID), £2$(£Cost, $Cost), {$Cost>500, $Cost<=500}, 0(0₁,0₂)).

Additionally, an ETL molecule may be expressed as a pentad of the form (I, m( ), P, r, O), where the definitions for the ETL atom apply. Also, P=[P₁(X₁) . . . , Pₙ(Xₙ)] may be a list of predicates, each corresponding to an ETL particle.

The order of the predicates may correspond to the order of the particles within the ETL molecule. For respective schemata Xᵢ=[Xᵢ₁ . . . , Xᵢₘ], the semantics of a tuple t arriving at an output schema Oᵢ may be expressed as merge(I) Λ P(t.X₁₁, . . . , t.Xₜₘ) Λ . . . Λ P(t.Xₙ₁, . . . , t.Xₙₘ) Λ φ₁.

An ETL compound then may be expressed as a tetrad of the form, (D_{f}, Dₛ, M, C), where D_{f} is a finite set of input recordsets, Dₛ is a finite set of output recordsets, M is a finite set of molecules, and C is a finite set of mappings between the molecules, M, and the recordsets, D_{f} and Dₛ.

For the ETL compound, the following well-formedness constraints hold. The schemata of input recordsets in D_{f} may be mapped to input schemata. Every schema of the recordsets of Dₛ may have the output schema of at least one activity mapped to it. A special case of sink, i.e., output, recordsets may not be further mapped to other schemata. No molecule may have unmapped schemata.

Further, a graph including a finite set of recordsets and molecules as nodes, and the mappings among them as directed edges is acyclic. Such a graph may have nodes and directed edges. The nodes may represent recordsets and molecules. The directed edges may represent mappings among the nodes. Such a graph may not include cycles. In other words, this graph is a directed acyclic graph (DAG).

The semantics of a molecule are given via a mapping, M, that maps input schemata to output schemata. The mapping may be expressed as M: attributes(I)→attributes(O), which is onto, but not necessarily total or bijective.

In scenarios where M is not total, there are attributes that are not propagated from the output of an ETL transformation to the corresponding input of a subsequent transformation. Additionally, new attributes may be generated. As such, the normal form may be extended to account for these scenarios.

Two schemata, π⁺ and π⁻, may be included. The first schemata, π⁺, may include the newly generated attributes. The second schemata, π⁻, may include the attributes that are not propagated.

Each ETL particle may be defined as P(X, Y), with X representing input parameters, and Y representing the generated parameters. A constraint may hold that for every particle Pₐ(Xₐ, Yₐ) in the molecular chain (routers included), its input parameters are a subset of the union of attributes of all the input schemata and the generated attributes of the previous particles. As such, a molecule can be defined as (I, m( ), P( ), r, π⁺, π⁻, O).

This treatment of schemata is useful, since there are two ways to populate the schema mapping function with the appropriate pairs either automatically or manually (as currently happens in ETL tools). Populating the schema mapping function automatically may involve computing schemata from the target of the workflow back towards its start, based on the templates. In such a case, the templates' parameters may be substantiated by specific attributes involved in the schema (e.g., the template NotNullₜ(p), where p is a template parameter that can be instantiated as NotNull(Sal), with Sal being a concrete input attribute). In this case, π⁺ and π⁻, may be assigned to compute the exact attributes that participate in the computed schemata.

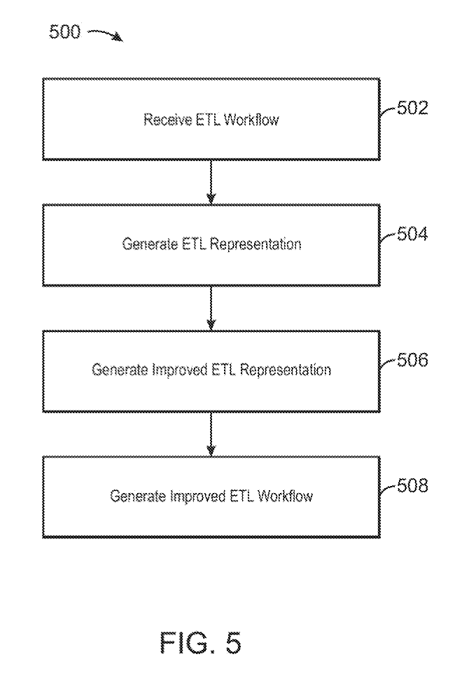

FIG. 5 is a process flow diagram showing a computer-implemented method 500 for generating ETL workflows according to an embodiment of the invention. The method is generally referred to by the reference number 500. It should be understood that the process flow diagram is, not intended to indicate a particular order of execution.

The method 500 begins at block 502, where an ETL workflow may be received. The ETL workflow may be proprietary to a particular ETL tool, and is referred to herein as the original ETL workflow.

At block 504, an ETL representation of the ETL workflow may be generated. The representation may include the normal form described above.

At block 506, an improved ETL representation may be generated. The improvement may be an improvement in performance, fault-tolerance, recoverability, maintainability, a more efficient use of resources, and the like.

Improvements may be accomplished in the improved ETL representation through the manipulation of ETL particles, ETL molecules, and ETL compounds in the original ETL representation. For example, ETL molecules may be composed from existing ETL atoms, ETL molecules may be split into smaller molecules, or ETL molecules may be coupled together. Further, ETL compounds may also be split or composed by an ETL tool, or an ETL optimizer, to improve the efficiencies of ETL workflows.

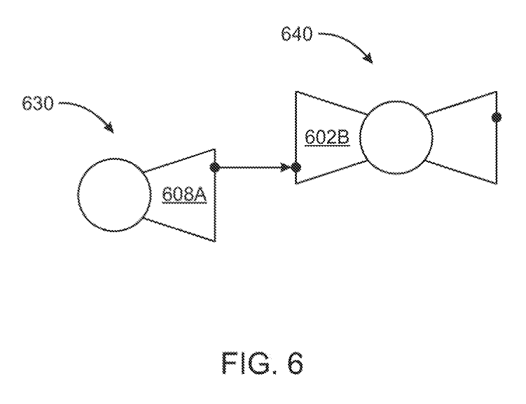

FIG. 6 illustrates two molecules 630, 640 coupled together according to an embodiment of the invention. The coupling of two molecules is a simple act of mapping the output 608A of one molecule 630 to the input 602B of the other molecule 640.

The molecule 630 may be expressed as (Iₐ, mₐ( ), Pₐ, rₐ, Oₐ). The molecule 640 may be expressed as (I_{b}, m_{b}( ), P_{b}, r_{b}, O_{b}). The output schemata Oₐ for the molecule 630 may include one output schemata, O_{a,j}. The input schemata I_{b} may include one input schemata I_{b,k}. The output schemata O_{a,j} may be mapped to the input schemata I_{b,k}.

For each tuple arriving at O_{a,j}, the semantics may be sem(I_{a,j}): mₐ(Iₐ) Λ Pₐ Λ φ₁. For each tuple arriving at O_{b}, the semantics may be sem(O_{b}): m_{b}(I_{b1} . . . , I_{bn}) Λ P_{b} Λ φ_{Ob}.

After the coupling, the semantics may be: m_{b}(I_{b1} . . . , I_{bk-1}, M(I_{bk}), I_{bk+1} . . . , I_{bn}) Λ P_{b} Λ φ_{Ob}=m_{b}(II_{b1} . . . , I_{bk-1}, (mₐ(Iₐ) Λ Pₐ Λ φᵢ), I_{bk+1} . . . , I_{bn}) Λ P_{b} Λ φ_{Ob}. Similarly, semantics can be defined for all inputs of molecule 640.

For example, a simple molecule with one input and one output can be coupled with another molecule of the same family as follows: sem(Oₐ)=sem(Iₐ)

Λ Pₐ, meaning that sem(O_{b})=sem(I_{b}) Λ P_{b}=sem(M(I_{b}) Λ P_{b}=sem(Iₐ) Λ Pₐ Λ P_{b}.

Referring back to FIG. 5, the original ETL workflow may also be improved by composing or splitting ETL molecules. The composition of molecules is an act of merging two ETL molecules into one. The inverse act, splitting, subtracts one ETL molecule from another.

Assuming two ETL molecules, a₁ and a₂, the ETL molecule, a₁, may be expressed as (I₁, m₁( ), P₁, r₁, O₁). The ETL molecule, a₂, may be expressed as a₂=(I₂, m₂( ), P₂, r₂, O₂). Under certain conditions, it may be possible to merge these two molecules. It may also be possible to show that there are cases where the two molecules cannot be merged.

If the molecule a₁ has exactly one output, O₁, the molecule a₂ has exactly one input I₂, and the attributes of O₁ are a superset of the attributes of I₁. In such a scenario, a new molecule, a₃ may be expressed as a₁ o a₂, or a₃=(I₃, m₃( ), P₃, r₃, O₃) such that I₃=I₁, m₃( )=m₁( ), P₃=P₁ U P₂, r3=r₂, and O₃=O₂.

A mapping may be devised among the two schemata. Accordingly, the semantics for the output of the second molecule, a₂ may be the same with the semantics for molecule a3.

However, serial composition is not always possible. On the contrary, the fact that routers are exactly before the outputs imposes a necessary constraint for composition.

Serial composition of two ETL molecules may not be a closed operation. Assume a molecule a₁ that has exactly 2 outputs (O_{1,1}, and O_{1,2}), and a second molecule, a₂, that has exactly one input I and one output O. Assume also a potential composition of the molecule a₂ with O_{1,1}. This is the simplest possible non-feasible case of serial composition. If the ETL molecules a₁ and a₂ are composed into one molecule a3=a₁ o a₂, then a3=(I₁, m₁( ), P₁ U P₂, r₁, π⁻₂, π⁺₂, O).

This is problematic because the tuples arriving at O_{1,2} may have semantics merge(I₁) Λ P_{1,1}(X_{1,1}) Λ P_{1,2} (X_{1,2}) Λ P₂(X₂) Λ φ₂, instead of the appropriate merge(I₁) Λ P_{1,1}(X_{1,1}) Λ P_{1,2}(X_{1,2}) Λ φ₂.

ETL molecules may be split by subtracting one ETL molecule from a larger ETL molecule. Subtraction is the inverse operation of composition and may produce an ETL molecule with fewer ETL particles, or schemata. Formally, assume two molecules, a₁ and a₂ that have the same merger, m. Accordingly, a new molecule may be defined, a₃=a1−a2, a3=(I₃, m, P₃, r₃, O₃) such that I₃={I₁ᵢ−I₂ᵢ} for all the input schema of I₁, P₃=P₁−P₂, r₃=[φ₁ . . . , φₙ], s.t, [symbol] φ_{1,i}→φ_{2,i} for all the selection conditions of the router r₁, O₃={O₁ᵢ−O₂ᵢ} for all the output schemata of O₁, and the attributes participating in the merger and router are still present after the subtraction of the input schemata.

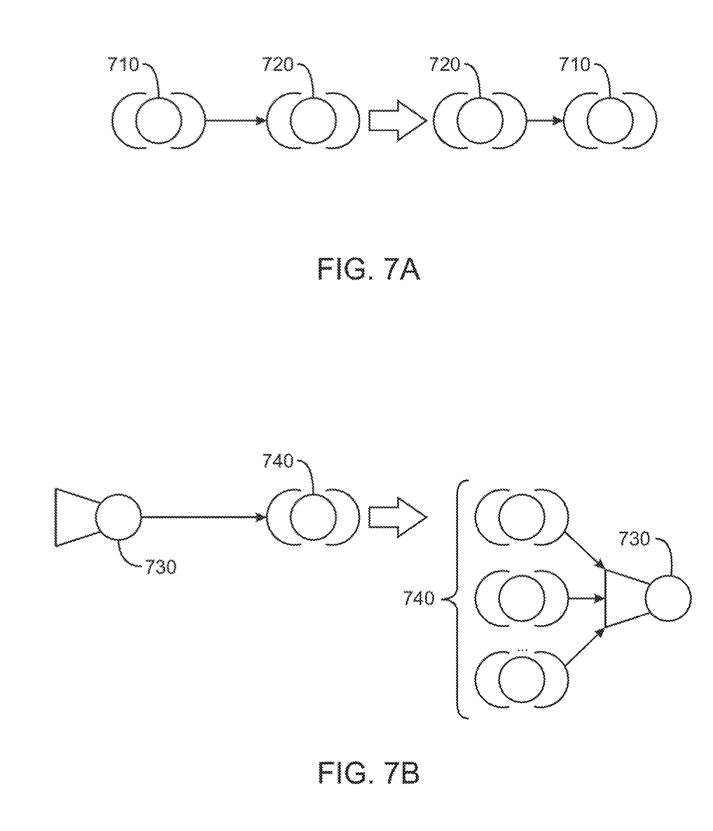

FIGS. 7A-7B are block diagrams that shows two variations of swapping ETL transformations according to an embodiment of the invention. A straightforward application of the manual generation of schemata may involve the swapping of ETL transformations. FIGS. 7A-7B show two ways that ETL transformations may be swapped. FIG. 7A shows the swapping of two unary transformations. Two unary transformations 710, 720 may be swapped if the attributes used for unary transformation 710 are still present after the execution of unary transformation 720.

FIG. 7B shows the swapping of an n-ary transformation 730 and a unary transformation 740. In this scenario, swapping brings the unary transformation 740 before all of the input schemata of the n-ary transformation 730. Similar to the first swapping, the transformations 730, 740 may be swapped if the attributes needed for n-ary transformation 730 to operate are still present after the execution of unary transformation 740.

Referring back to FIG. 5, at block 508, an improved ETL workflow may be generated. Thee improved ETL workflow may be based on the improved ETL representation. In one embodiment of the invention, the improved ETL workflow may be generated for a different ETL tool than the ETL tool that generated the original ETL workflow.

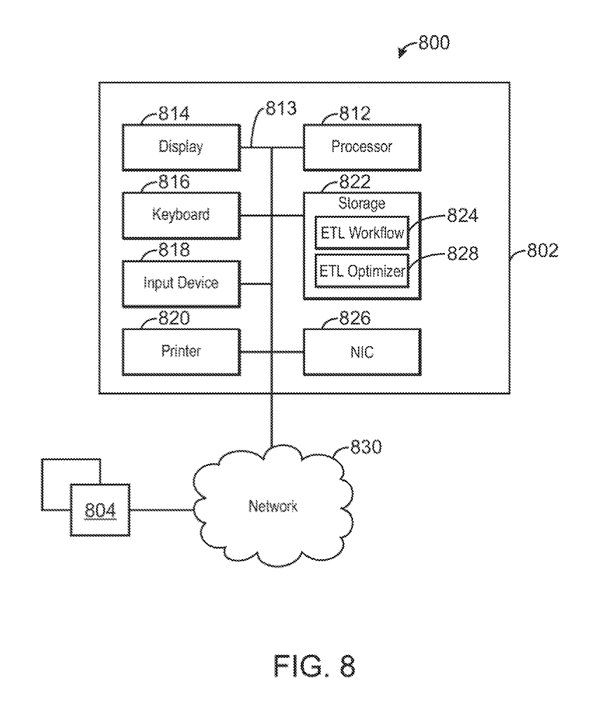

FIG. 8 is a block diagram of a system adapted to generate ETL workflows according to an embodiment of the present invention. The system is generally referred to by the reference number 800. Those of ordinary skill in the art will appreciate that the functional blocks and devices shown in FIG. 8 may comprise hardware elements including circuitry, software elements including computer code stored on a non-transitory, machine-readable medium or a combination of both hardware and software elements.

Additionally, the functional blocks and devices of the system 800 are but one example of functional blocks and devices that may be implemented in an embodiment of the present invention. Those of ordinary skill in the art would readily be able to define specific functional blocks based on design considerations for a particular electronic device.

The system 800 may include an ETL server 802, and one or more source systems 804, in communication over a network 830. As illustrated in FIG. 8, the ETL server 802 may include a processor 812 which may be connected through a bus 813 to a display 814, a keyboard 816, one or more input devices 818, and an output device, such as a printer 820. The input devices 818 may include devices such as a mouse or touch screen.

The ETL server 802 may also be connected through the bus 813 to a network interface card (NIC) 826. The NIC 826 may connect the database server 802 to the network 830. The network 830 may be a local area network (LAN), a wide area network (WAN), such as the Internet, or another network configuration. The network 830 may include routers, switches, modems, or any other kind of interface device used for interconnection.

Through the network 830, several source systems 804 may connect to the ETL server 802. The source systems 804 may be similarly structured as the ETL server 802, with exception to the storage 822.

The ETL server 802 may have other units operatively coupled to the processor 812 through the bus 813. These units may include non-transitory, machine-readable storage media, such as a storage 822. The storage 822 may include media for the long-term storage of operating software and data, such as hard drives.

The storage 822 may also include other types of non-transitory, machine-readable media, such as read-only memory (ROM), random access memory (RAM), and cache memory. The storage 822 may include the software used in embodiments of the present techniques.

The storage 822 may include an ETL workflow 824 and an ETL optimizer 828. In an embodiment of the invention, the ETL optimizer 828 may translate the ETL workflow 824 into a symbolic representation as described above, modify the symbolic representation with an improvement, and generate a new ETL workflow based on the improvement.

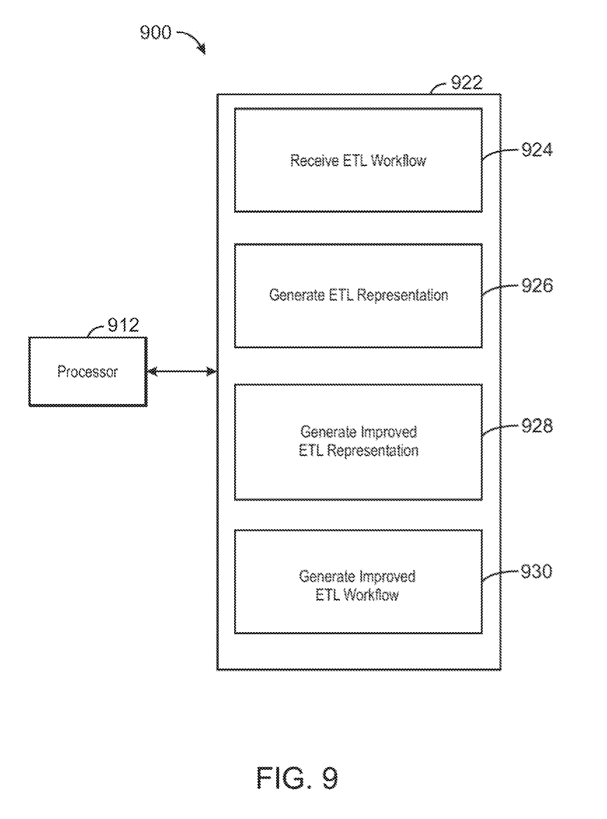

FIG. 9 is a block diagram showing a system 900 with a non-transitory, machine-readable medium that stores code adapted to generate an ETL workflow according to an embodiment of the present invention. The non-transitory, machine-readable medium is generally referred to by the reference number 922.

The non-transitory, machine-readable medium 922 may correspond to any typical storage device that stores computer-implemented instructions, such as programming code or the like. For example, the non-transitory, machine-readable medium 922 may include a storage device, such as the storage 822 described with reference to FIG. 8.

A processor 902 generally retrieves and executes the computer-implemented instructions stored in the non-transitory, machine-readable medium 922 to generate ETL workflows.

A region 924 may include instructions that receive an ETL workflow 824. A region 926 may include instructions that generate an ETL representation, as described with reference to FIG. 4. A region 928 may include instructions that generate an improved ETL representation. A region 930 may include instructions that generate an improved ETL workflow based on the improved ETL representation. The instructions may be expressed in various languages or formats, and may be used by various ETL tools.

What is claimed is:

1. A computer system (800) for generating an extract, transform, and load (ETL) workflow (824), the computer system (800) comprising a processor (812) configured to:
receive (502) an ETL workflow (824);
generate (504) a symbolic representation of the ETL workflow (824);
generate (506) an improved representation, wherein the improved representation is a symbolic representation of an improved ETL workflow; and
generate (508) the improved ETL workflow based on the improved representation.

2. The computer system recited in claim 1, wherein the symbolic representation of the ETL workflow comprises at least one of:
an ETL particle that represents an ETL activity;
an ETL atom that represents an ETL transformation;
an ETL molecule that comprises one or more ETL atoms;
an ETL compound that represents an ETL workflow; and
combinations thereof.

3. The computer system recited in claim 2, wherein the ETL atom comprises:
an input schemata;
the ETL particle; and
an output schemata.

4. The computer system of claim 1, wherein generating the improved representation comprises at least one of:
swapping a first ETL atom with a second ETL atom;
composing an ETL molecule from one or more ETL atoms;
composing a first ETL compound from one or more ETL molecules;
splitting a first ETL molecule into a second ETL molecule and a third ETL molecule;
splitting a second ETL compound into or more ETL molecules; and
combinations thereof.

5. The computer system recited in claim 1, wherein the processor is configured to execute the improved ETL workflow, wherein execution of the improved ETL workflow uses fewer resources than an execution of the ETL workflow.

6. The computer system recited in claim 1, wherein the ETL workflow is proprietary to a first ETL tool, and wherein the improved ETL workflow is proprietary to a second ETL tool.

7. The computer system recited in claim 1, wherein the ETL workflow is proprietary to a first ETL tool, and the improved ETL workflow is proprietary to the first ETL tool, and wherein the processor is configured to:
receive a second ETL workflow that is proprietary to a second ETL tool;
generates a symbolic representation of the second ETL workflow;
generates a second improved representation, wherein the second improved representation is a second symbolic representation of a second improved ETL vvorkflow; and
generates the second improved ETL workflow based on the second improved representation, wherein the second improved ETL workflow is proprietary to the second ETL tool.

8. The computer system recited in claim 1, wherein the symbolic representation of the ETL workflow is generated by interpreting the ETL workflow using a common language and a formal normal form.

9. A method for generating an extract, tran and load (ETL) workflow, comprising:
receiving (502) an ETL workflow (824);
generating (504) a symbolic representation (400) of the ETL workflow (824), wherein the symbolic representation of the ETL workflow comprises at least one of:
an ETL particle (206A, 206B, 206C, 206D, 306B, 406A, 406B) that represents an ETL activity;
an ETL atom (200A, 200B, 200C, 200D) that represents an ETL transformation (100);
an ETL molecule (400) that comprises one or more ETL atoms (200A, 200B, 200C, 200D);
an ETL compound that represents an ETL workflow;
generating (506) an improved representation, wherein the improved representation is a symbolic representation of an improved ETL workflow; and
generating (508) the improved ETL workflow based on the improved representation.

10. The method recited in claim 9, wherein the ETL atom comprises:
an input schemata;
the ETL particle; and
an output schemata.

11. The method recited in claim 9, wherein generating the improved representation comprises at least one of:
swapping a first ETL atom with a second ETL atom;
composing an ETL molecule from one or more ETL atoms;
composing a first ETL compound from one or more ETL molecules;
splitting a first ETL molecule into a second ETL molecule and a third ETL molecule;
splitting a second ETL compound into two or more ETL molecules; and
combinations thereof.

12. A non-transitory, computer-readable medium (822, 922) comprising machine-readable instructions executable by a processor (812, 912) generating an extract, transform, and load (ETL) workflow (824), the non-transitory, computer-readable medium comprising:
computer-readable instructions (924) that, when executed by the processor, receive an ETL workflow (824)
computer-readable instructions (926) that, when executed by the processor, generate an ETL representation of the ETL workflow (824);
computer-readable instructions (928) that, when executed by the processor, generate an improved ETL representation, wherein the improved representation is a symbolic representation of an improved ETL workflow;
computer-readable instructions (930) that, when executed by the processor, generate a first improved ETL workflow based on the improved ETL representation, wherein the first improved ETL workflow is proprietary to a first ETL tool; and
computer-readable instructions (930) that, when executed by the processor, generate a second improved ETL workflow based on the improved ETL representation, wherein the second improved ETL workflow is proprietary to a second ETL tool.

13. The non-transitory, computer-readable medium recited in claim 12, wherein the symbolic representation of the ETL workflow comprises an ETL atom that represents an ETL transformation. wherein the ETL atom comprises:
an input schemata;
the ETL particle; and
an output schemata.

14. The non-transitory, computer-readable medium recited in claim 13, wherein the symbolic representation of the ETL workflow comprises at least one of:
an ETL particle that represents an ETL activity;
an ETL molecule that comprises one or more ETL atoms;
an ETL compound that represents an ETL workflow; and
combinations thereof.

15. The non-transitory, computer-readable medium recited in claim 12, wherein execution of the first improved ETL workflow uses fewer resources than an execution of the ETL workflow.
